(19) United States
(12) Patent Application Publication
(10) Pub. No.: US 2008/0047403 A1
(43) Pub. Date: Feb. 28, 2008

(54) Tool locking device

(76) Inventor: Hsiu Nien Lin, Taichung Hsien (TW)

Correspondence Address: CHARLES E. BAXLEY, ESQ., 90 JOHN STREET, THIRD FLOOR, NEW YORK, NY, 10038, US

(21) Appl. No.: 11/729,246

(22) Filed: Mar. 27, 2007

(30) Foreign Application Priority Data
Aug. 23, 2006 (TW) 095214930

(51) Int. Cl. B25B 23/00

(52) U.S. Cl. 81/177.85

(57) ABSTRACT

A tool locking device includes a tool shank having a bore for slidably receiving a shaft, a detent slidably received in the tool shank for detachably engaging with a tool member, a shaft slidably engaged into the tool shank and having a recess for selectively receiving the detent and having an actuating portion for forcing the detent to engage with the tool member, a button slidably received in the tool shank for actuating the actuating portion of the shaft to engage with the detent. and a shielding device has an opening and a slot for engaging the button through the slot and into the opening of the shielding device for shielding and protecting the button and for preventing the button from being operated inadvertently.

### BACKGROUND OF THE INVENTION

1. Field of the Invention

The present invention relates to a tool locking device, and more particularly to a tool locking device for engaging in a longitudinal tool shank or stem and including an actuator for engaging with and for actuating a pawl or detent to engaging with a tool member or fastener to be rotated or driven by the tool shank and for anchoring or coupling the tool member or fastener to the tool shank and for preventing the tool member or fastener from being disengaged from the tool shank inadvertently.

2. Description of the Prior Art

Typical tool locking devices comprise a pawl or detent slidably engaged into one end of a longitudinal shaft, and a locking bolt slidably received in the longitudinal shaft and engageable with the pawl or detent for forcing the detent to move out of the longitudinal shaft and to engage with the tool member or fastener to be rotated or driven by the shaft.

For example, U.S. Pat. No. 4,781,085 to Fox, III discloses one of the typical locking socket wrench extensions comprising a detent slidably engaged into one end of a shaft, and a locking bolt slidably received in the shaft and engageable with the detent for forcing the detent to engage with the tool member or fastener to be rotated or driven by the shaft, and a thumb lever slidably engaged in a thumb lever channel of the shaft and coupled to the locking bolt for moving the locking bolt to force or to actuate or to operate the detent.

However, the thumb lever is exposed and has not been shielded or protected and will be touched and operated by children inadvertently.

U.S. Pat. No. 5,660,491 to Roberts et al. discloses one of the typical universal joints for torque transmitting tools comprising a detent slidably engaged into one part of the universal joint, and a shaft slidably received in the part of the universal joint and engageable with the detent for forcing the detent to engage with the tool member or fastener to be rotated or driven by the part of the universal joint, and an actuator slidably engaged in the part of the universal joint and coupled to the shaft for moving the shaft to force or to actuate or to operate the detent.

However, the actuator is also exposed and has not been shielded or protected and thus will be touched and operated by children inadvertently.

U.S. Pat. No. 6,267,032 to Hsieh discloses one of the typical drive type adapter comprising a detent slidably engaged into a fitting section of a main body, and a slide rod slidably received in the fitting section of the main body and engageable with the detent for forcing the detent to engage with the tool member or fastener to be rotated or driven by the fitting section of the main body, and a rotary bar rotatably engaged in the fitting section of the main body and coupled to the slide rod for moving the slide rod to force or to actuate or to operate the detent.

However, the slide rod is also exposed and has not been shielded or protected and thus will be touched and operated by children inadvertently.

U.S. Pat. No. 6,755,100 to Chen discloses one of the typical tools having a quick release and positive locking device and comprising a detent or latch pin slidably engaged into a tool shank, and a button slidably received in or engaged into the tool shank and engageable with the latch pin for forcing the latch pin to engage with the tool member or fastener to be rotated or driven by the tool shank.

However, the button is also exposed and has not been shielded or protected and thus will be touched and operated by children inadvertently.

The present invention has arisen to mitigate and/or obviate the afore-described disadvantages of the conventional tool locking devices.

### SUMMARY OF THE INVENTION

The primary objective of the present invention is to provide a tool locking device including an actuator for engaging with and for actuating a pawl or detent to engaging with a tool member or fastener to be rotated or driven by the tool shank and for anchoring or coupling the tool member or fastener to the tool shank and for preventing the tool member or fastener from being disengaged from the tool shank inadvertently.

In accordance with one aspect of the invention, there is provided a tool locking device comprising a tool shank including a bore formed in a free end portion thereof, and including an orifice and an aperture formed therein and communicating with the bore of the tool shank, a detent slidably received in the orifice of the tool shank and engaged into the bore of the tool shank and partially extendible out of the tool shank for engaging with a tool member to be driven by the tool shank and for detachably anchoring the tool member to the tool shank, an actuator including a shaft slidably engaged into the bore of the tool shank, and the shaft including a recess formed therein for selectively receiving the detent and for allowing the detent to be selectively engaged into the orifice of the tool shank and for allowing the detent to be selectively disengaged from the tool member, and the shaft including an actuating portion for selectively engaging with the detent and for selectively forcing the detent to partially move out of the orifice of the tool shank and to engage with the tool member, a button slidably received in the aperture of the tool shank and engaged into the bore of the tool shank and including an upper portion extendible out of the tool shank for being actuated by a user, the button being engaged with the shaft for selectively actuating the shaft to move along the bore of the tool shank and for selectively actuating the actuating portion of the shaft to engage with the detent, and a shielding device including a chamber formed therein for slidably receiving the tool shank and for allowing the shielding device to be attached onto the tool shank, the shielding device including an opening formed therein and formed through the shielding device and communicating with the chamber of the shielding device for slidably receiving the button and for anchoring the shielding device to the tool shank, the shielding device further including a slot formed therein and communicating with the opening of the shielding device for allowing the button to be engaged through the slot and engaged into the opening of the shielding device, and for shielding and protecting the button with the shielding device and for preventing the button from being operated inadvertently.

The slot of the shielding device includes a width smaller than an inner diameter of the opening of the shielding device for anchoring the button to the shielding device and for preventing the button from being disengaged from the opening of the shielding device, and thus for preventing the shielding device from being disengaged from the tool shank. The shielding device is preferably made of elastic materials.

The shielding device includes a depression formed in an outer peripheral portion thereof and communicating with the opening of the shielding device for allowing the button to be depressed into the depression of the shielding device.

The shielding device includes at least one protrusion extended into the chamber of the shielding device for force-fitting and engaging with the tool shank and for anchoring the shielding device to the tool shank, and the shielding device may further include at least one projection extended into the chamber of the shielding device for engaging with the tool shank and for anchoring the shielding device to the tool shank.

The tool shank includes at least one ramp formed therein for engaging with the projection of the shielding device and for anchoring the shielding device to the tool shank. The tool shank includes a driving section provided in the free end portion thereof and having a noncircular cross section and having at least one flat surface formed thereon, and the ramp is formed between the flat surface of the driving section and the tool shank.

The button includes a cavity formed therein, and the shaft includes an operating member engaged into the cavity of the button for allowing the button to selectively actuate the shaft to move along the bore of the tool shank. The button preferably includes an inclined surface formed therein for forming the cavity of the button, and the shaft includes an inclined surface formed in the operating member for slidably engaging with the inclined surface of the button.

The button includes a notch formed in a lower portion of the button for forming a stem in the lower portion of the button, and the shaft includes a space formed therein for slidably receiving the stem of the button. The tool shank includes a spring member engaged with the shaft for forcing and actuating the actuating portion of the shaft to engage with the detent and to force the detent to move out of the orifice of the tool shank.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a tool locking device in accordance with the present invention;

FIG. 2 is a perspective view illustrating a button of the tool locking device;

FIG. 3 is a partial perspective view of the tool locking device;

FIG. 4 is a partial cross sectional view of the tool locking device taken along lines 4-4 of FIG. 3;

FIG. 5 is a partial cross sectional view similar to FIG. 4, illustrating the operation of the tool locking device;

FIG. 6 is a partial top plan schematic view of the tool locking device;

FIG. 7 is a partial top plan schematic view similar to FIG. 6, illustrating the operation of the tool locking device; and

FIG. 8 is a partial top plan schematic view similar to FIGS. 6 and 7 illustrating the further arrangement or application of the tool locking device.

### DETAILED DESCRIPTION OF THE PREFERRED EMBODIMENT

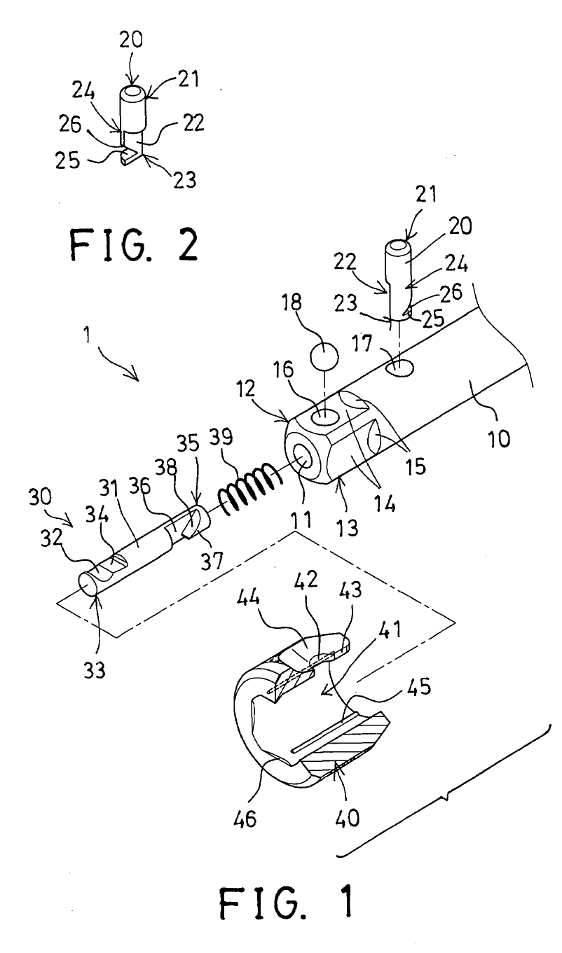

Referring to the drawings, and initially to FIGS. 1-4, a tool locking device 1 in accordance with the present invention comprises a tool shank 10 including a longitudinal bore 11 formed in one end or free end portion 12 thereof and opened through the free end portion 12 thereof, and including a driving section 13 formed or provided in the free end portion 12 thereof and having a noncircular cross section or having one or more flat surfaces 14 formed in the outer peripheral portion thereof, and including an inclined surface or ramp 15 formed between each of the flat surfaces 14 of the driving section 13 and the tool shank 10. The tool shank 10 further includes an orifice 16 and an aperture 17 formed therein and perpendicular to the tool shank 10 and intersecting and/or communicating with the bore 11 of the tool shank 10.

For example, the orifice 16 of the tool shank 10 is formed in the driving section 13 and the tool shank 10, and the aperture 17 is formed in the tool shank 10 and offset or spaced from the orifice 16 of the tool shank 10. A detent 18, such as a spherical detent 18 is slidably received in the orifice 16 of the tool shank 10 and engaged into the bore 11 of the tool shank 10 and partially extended out of the tool shank 10 for engaging with a fastener or tool member 80 to be rotated or driven by the tool shank 10 and for detachably anchoring or coupling the tool member 80 to the tool shank 10. A button 20 is slidably received in the aperture 17 of the tool shank 10 and engaged into the bore 11 of the tool shank 10 and includes an upper portion 21 extendible out of the tool shank 10 for being depressed or actuated or operated by the users.

The button 20 further includes a cutoff portion or notch 22 formed in the lower portion 23 of the button 20 for forming or defining a stem 24 in the lower portion 23 of the button 20, in which the stem 24 is engageable into the bore 11 of the tool shank 10 and includes a substantially semi-cylindrical structure or shape, the button 20 further includes a cavity 25 formed in the lower portion 23 of the button 20, and an inclined surface 26 also formed in the lower portion 23 of the button 20 and located above the cavity 25 of the button 20 for forming or defining the cavity 25 of the button 20. The cavity 25 and the inclined surface 26 of the button 20 may also be engaged into the bore 11 of the tool shank 10.

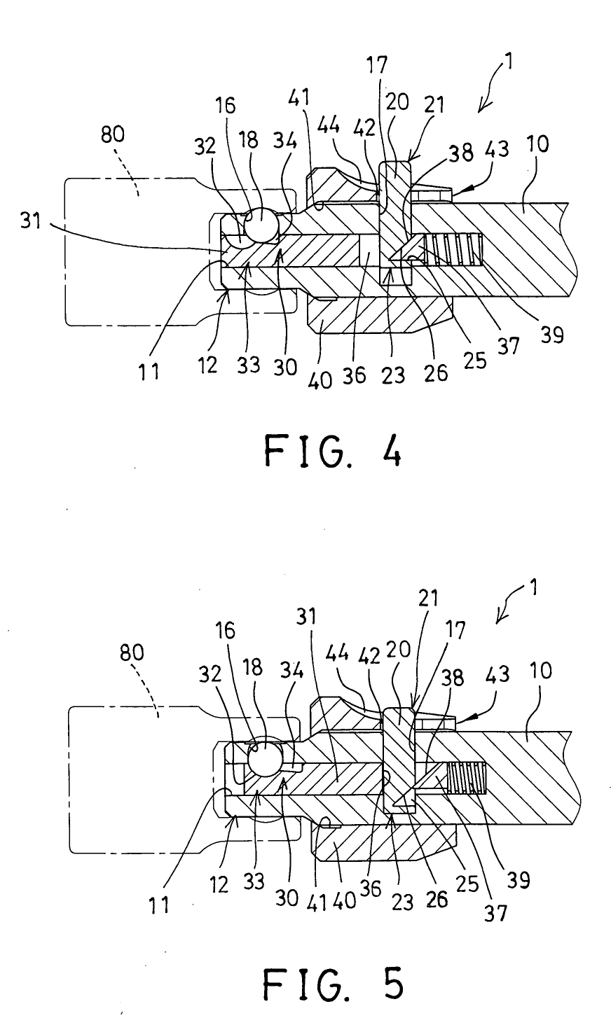

An actuator 30 includes a shaft 31 slidably engaged into the bore 11 of the tool shank 10, and the shaft 31 includes a recess 32 formed in one end or outer end portion 33 of the shaft 31 for selectively receiving the detent 18 (FIG. 5) and for allowing the detent 18 to be selectively and completely engaged into the orifice 16 and the bore 11 of the tool shank 10 and for allowing the detent 18 to be selectively disengaged from the tool member 80, and thus for allowing the tool member 80 to be selectively removed or disengaged from the tool shank 10. It is preferable that the shaft 31 includes a platform or actuating portion 34 formed or located beside the recess 32 of the shaft 31 for selectively engaging with the detent 18 (FIG. 4) and for selectively forcing the detent 18 to partially move out of the orifice 16 of the tool shank 10 and to engage with the tool member 80.

The shaft 31 further includes another end or inner end portion 35 having a cutoff portion or space 36 formed therein for slidably receiving the button 20 or the stem 24, and having an operating member 37 extended into the space 36 of the shaft 31 for selectively engaging into the cavity 25 of the button 20 and for engaging with the button 20, and having an inclined surface 38 formed in the upper portion of the operating member 37 for slidably engaging with the corresponding inclined surface 26 of the button 20 and for selectively forcing or actuating the button 20 to move outwardly or inwardly relative to the tool shank 10 when the shaft 31 of the actuator 30 is slid or moved along the bore 11 of the tool shank 10, or relatively, the button 20 may force or actuate the shaft 31 of the actuator 30 to slide or move along or into and out of the bore 11 of the tool shank 10.

A spring member 39 is also engaged into the bore 11 of the tool shank 10, and engaged with the shaft 31 for biasing or forcing or actuating the shaft 31 to move outwardly relative to the tool shank 10, and/or for forcing or actuating the actuating portion 34 of the shaft 31 to engage with the detent 18 (FIG. 4) and to force the detent 18 to partially move out of the orifice 16 of the tool shank 10 and to engage with the tool member 80 in order to detachably anchor or couple or secure the tool member 80 to the tool shank 10. The sliding engagement of the inclined surface 38 of the operating member 37 of the actuator 30 with the inclined surface 26 of the button 20 may selectively force or actuate the shaft 31 of the actuator 30 to move along the bore 11 of the tool shank 10 and/or outwardly relative to the tool shank 10 or inwardly against the spring member 39 when the button 20 is depressed relative to the tool shank 10 or depressed or moved into the aperture 17 of the tool shank 10.

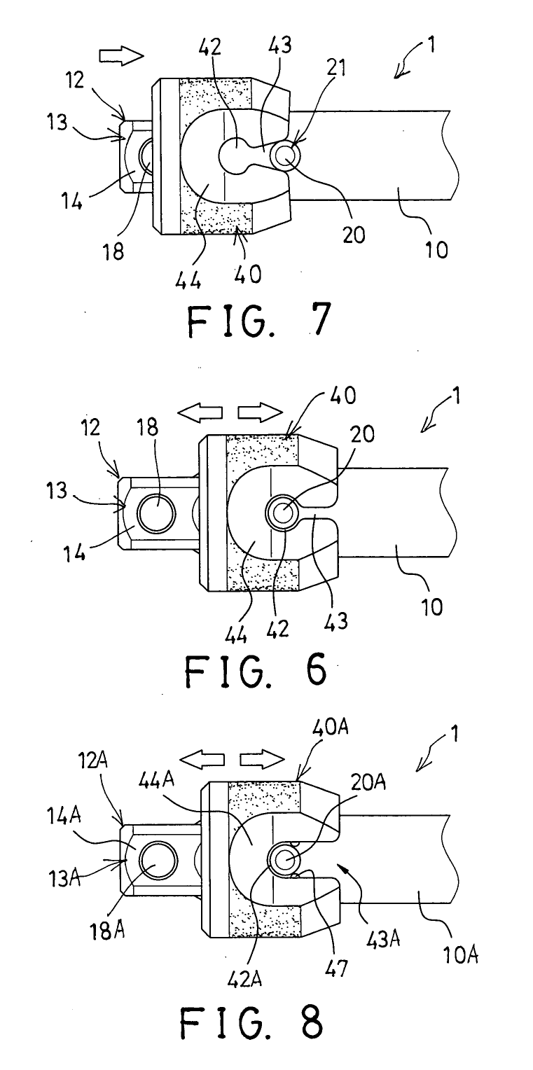

A shielding or protecting device 40 is further provided and attached or engaged onto the tool shank 10, and includes a bore or chamber 41 formed therein for slidably receiving the tool shank 10 and for allowing the shielding device 40 to be attached or engaged onto the tool shank 10. The shielding device 40 includes an opening 42 formed therein and formed through the shielding device 40 and communicating with the chamber 41 of the shielding device 40 for slidably receiving the button 20 and thus for anchoring or coupling the shielding device 40 to the tool shank 10. The shielding device 40 further includes a slot 43 formed therein and communicating with the opening 42 of the shielding device 40 for opening the opening 42 of the shielding device 40 and for allowing the button 20 to be engaged into the opening 42 via the slot 43 of the shielding device 40 (FIGS. 6, 7).

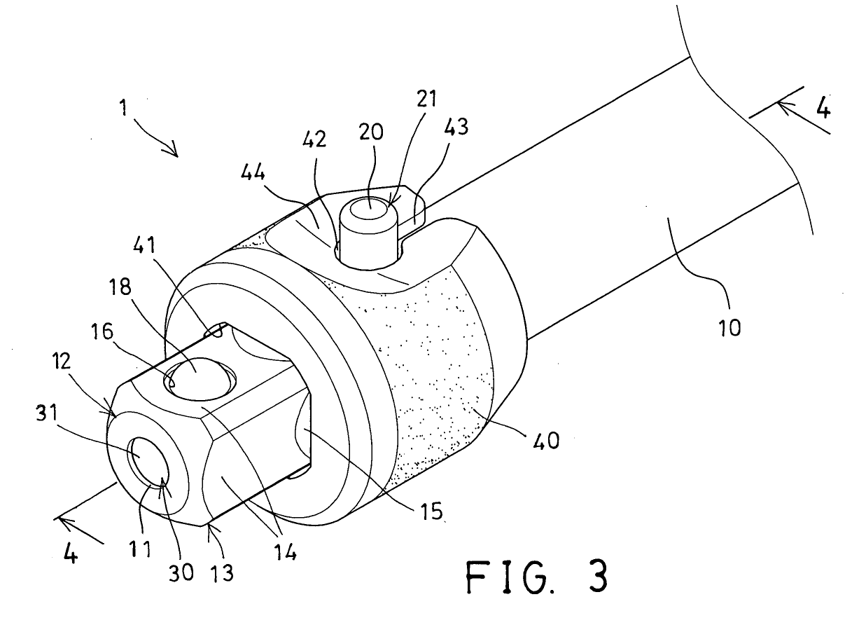

It is preferable that the shielding device 40 is made of soft or rubber or plastic or elastic or resilient or synthetic materials that may be slightly deformed or squeezed or stretched for allowing the button 20 to be forced through the slot 43 of the shielding device 40 (FIG. 7) and then engaged into the opening 42 of the shielding device 40 (FIGS. 3-6) easily when the button 20 is engaged in the aperture 17 of the tool shank 10. The slot 43 of the shielding device 40 includes a size or dimension or width smaller than the inner diameter of the opening 42 of the shielding device 40 for anchoring or coupling or securing the button 20 to the shielding device 40 and for preventing the button 20 from being disengaged from the opening 42 of the shielding device 40, and thus for preventing the shielding device 40 from being disengaged from the tool shank 10.

The shielding device 40 includes a selected or suitable size or dimension or thickness for preventing the button 20 from being completely depressed and engaged into the aperture 17 of the tool shank 10, or for limiting the button 20 to move relative to the aperture 17 of the tool shank 10, and the shielding device 40 includes a selected or suitable softness or resilience for allowing the button 20 to be further depressed and engaged into the aperture 17 of the tool shank 10 against the elastic or resilient shielding device 40 in order to operate or to actuate the shaft 31 of the actuator 30. It is preferable that the shielding device 40 further includes a depression 44 formed in the outer peripheral portion thereof and communicating with the opening 42 and/or the slot 43 of the shielding device 40 for allowing the button 20 to be suitably depressed and engaged into the depression 44 of the shielding device 40 (FIG. 5).

In operation, as shown in FIG. 4, the shielding device 40 includes a selected or suitable thickness for preventing the button 20 from being completely depressed and engaged into the aperture 17 of the tool shank 10, and/or for preventing the actuator 30 from being operated or actuated by the limiting the button 20 inadvertently unless the button 20 is depressed and engaged into the aperture 17 of the tool shank 10 and/or depressed and engaged into the depression 44 of the shielding device 40 (FIG. 5) by the users. The formation and the provision and the communication of the slot 43 with the opening 42 of the shielding device 40 allow the button 20 to be forced through the slot 43 of the shielding device 40 (FIG. 7) and then engaged into the opening 42 of the shielding device 40 (FIGS. 3-6) easily when the button 20 is engaged in the aperture 17 of the tool shank 10 without removing the button 20 from the tool shank 10.

It is preferable that the shielding device 40 further includes one or more ribs or protrusions 45 extended into the chamber 41 of the shielding device 40 for force-fitting or engaging with the tool shank 10 and for resiliently anchoring or force-fitting the shielding device 40 to the tool shank 10 and thus for preventing the shielding device 40 from being easily moved relative to the tool shank 10. The shielding device 40 may further include one or more stops or projections 46 extended into the chamber 41 of the shielding device 40 from one end of the shielding device 40 for selectively engaging with the inclined surfaces or ramps 15 of the tool shank 10 (FIGS. 4, 5) and for further anchoring or positioning the shielding device 40 to the tool shank 10.

Alternatively, as shown in FIG. 8, a tool shank 10A is also provided and includes a driving section 13A formed or provided in the free end portion 12A thereof and having a noncircular cross section or having one or more flat surfaces 14A formed in the outer peripheral portion thereof, and the tool shank 10A also includes a detent 18A slidably engaged into the tool shank 10A, and the tool shank 10A also includes a button 20A slidably engaged into the tool shank 10A, and a shielding device 40A is also provided and includes an opening 42A and a slot 43A formed therein for allowing the button 20A to be engaged into the slot 43A and the opening 42A of the shielding device 40A, and includes a depression 44A formed in the outer peripheral portion thereof and communicating with the opening 42A and/or the slot 43A of the shielding device 40A for allowing the button 20A to be suitably depressed and engaged into the depression 44A of the shielding device 40A.

The shielding device 40 may further include one or more (such as two) stops or anchoring juts 47 extended into the opening 42A and/or the slot 43A of the shielding device 40A for engaging with the button 20A for anchoring or coupling or securing the button 20A to the shielding device 40A, and for preventing the button 20A from being disengaged from the opening 42A of the shielding device 40A, and thus for preventing the shielding device 40A from being disengaged from the tool shank 10A. The provision and the communication of the slot 43A with the opening 42A of the shielding device 40A and the extension of the anchoring juts 47 into the opening 42A and/or the slot 43A of the shielding device 40A allow the button 20A to be forced through the slot 43A of the shielding device 40A and then engaged into the opening 42A of the shielding device 40A easily when the button 20A is engaged in the tool shank 10A without removing the button 20A from the tool shank 10A.

Accordingly, the tool locking device in accordance with the present invention includes an actuator for engaging with and for actuating a pawl or detent to engaging with a tool member or fastener to be rotated or driven by the tool shank and for anchoring or coupling the tool member or fastener to the tool shank and for preventing the tool member or fastener from being disengaged from the tool shank inadvertently.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A tool locking device comprising:
a tool shank including a bore formed in a free end portion thereof, and including an orifice and an aperture formed therein and communicating with said bore of said tool shank,
a detent slidably received in said orifice of said tool shank and engaged into said bore of said tool shank and partially extendible out of said tool shank for engaging with a tool member to be driven by said tool shank and for detachably anchoring the tool member to said tool shank,
an actuator including a shaft slidably engaged into said bore of said tool shank, and said shaft including a recess formed therein for selectively receiving said detent and for allowing said detent to be selectively engaged into said orifice of said tool shank and for allowing said detent to be selectively disengaged from the tool member, and said shaft including an actuating portion for selectively engaging with said detent and for selectively forcing said detent to partially move out of said orifice of said tool shank and to engage with the tool member,
a button slidably received in said aperture of said tool shank and engaged into said bore of said tool shank and including an upper portion extendible out of said tool shank for being actuated by a user, said button being engaged with said shaft for selectively actuating said shaft to move along said bore of said tool shank and for selectively actuating said actuating portion of said shaft to engage with said detent, and
a shielding device including a chamber formed therein for slidably receiving said tool shank and for allowing said shielding device to be attached onto said tool shank, said shielding device including an opening formed therein and formed through said shielding device and communicating with said chamber of said shielding device for slidably receiving said button and for anchoring said shielding device to said tool shank, said shielding device further including a slot formed therein and communicating with said opening of said shielding device for allowing said button to be engaged through said slot and engaged into said opening of said shielding device, said slot of said shielding device including a width smaller than an inner diameter of said opening of said shielding device for anchoring said button to said shielding device and for preventing said button from being disengaged from said opening of said shielding device, and thus for preventing said shielding device from being disengaged from said tool shank, and said shielding device including a depression formed in an outer peripheral portion thereof and communicating with said opening of said shielding device for allowing said button to be depressed into said depression of said shielding device.

2-4. (canceled)

5. The tool locking device as claimed in claim 1, wherein said shielding device includes at least one protrusion extended into said chamber of said shielding device for force-fitting and engaging with said tool shank and for anchoring said shielding device to said tool shank.

6. The tool locking device as claimed in claim 1, wherein said shielding device includes at least one projection extended into said chamber of said shielding device for engaging with said tool shank and for anchoring said shielding device to said tool shank.

7. The tool locking device as claimed in claim 6, wherein said tool shank includes at least one ramp formed therein for engaging with said at least one projection of said shielding device and for anchoring said shielding device to said tool shank.

8. The tool locking device as claimed in claim 7, wherein said tool shank includes a driving section provided in said free end portion thereof and having a noncircular cross section and having at least one flat surface formed thereon, and said at least one ramp is formed between said at least one flat surface of said driving section and said tool shank.

9. The tool locking device as claimed in claim 1, wherein said button includes a cavity formed therein, and said shaft includes an operating member engaged into said cavity of said button for allowing said button to selectively actuate said shaft to move along said bore of said tool shank.

10. The tool locking device as claimed in claim 9, wherein said button includes an inclined surface formed therein for forming said cavity of said button, and said shaft includes an inclined surface formed in said operating member for slidably engaging with said inclined surface of said button.

11. The tool locking device as claimed in claim 1, wherein said button includes a notch formed in a lower portion of said button for forming a stem in said lower portion of said button, and said shaft includes a space formed therein for slidably receiving said stem of said button.

12. The tool locking device as claimed in claim 1, wherein said tool shank includes a spring member engaged with said shaft for forcing and actuating said actuating portion of said shaft to engage with said detent and to force said detent to move out of said orifice of said tool shank.
